(19) United States
(12) Patent Application Publication
(10) Pub. No.: US 2017/0305486 A1
(43) Pub. Date: Oct. 26, 2017

(54) HAND GUARD

(71) Applicant: Peter Sever, Mississauga (CA)

(72) Inventor: Peter Sever, Mississauga (CA)

(21) Appl. No.: 15/496,259

(22) Filed: Apr. 25, 2017

Related U.S. Application Data
(60) Provisional application No. 62/326,935, filed on Apr. 25, 2016.

(51) Int. Cl. B62J 23/00

(52) U.S. Cl. CPC B62J 23/00

(57) ABSTRACT

A hand guard apparatus mounted onto the handle bars of a vehicle for protecting the hand of a user of the vehicle as the user grips the handle bars. The hand guard apparatus includes a bracket that includes an orifice, a pivot bolt substantially cylindrical in shape, the pivot bolt arranged in the orifice, a body portion connected to the bracket, and a pivot bolt fastener configured to retain the pivot bolt and the bracket.

### CROSS-REFERENCE TO RELATED APPLICATION

This non-provisional application claims priority to U.S. Provisional Application No. 62/326,935, filed Apr. 25, 2016, which is incorporated herein in its entirety.

### BACKGROUND

The present disclosure relates to vehicles such as motorcycles, motor bikes, non-motorized bicycles, and all-terrain vehicles (ATVs) and, more specifically, to a hand guard for a vehicle hand grip.

While operating a vehicle such as a motorcycle, motor bike, non-motorized bicycle, or all-terrain vehicle (ATV), a user may desire protection from weather, elements, and objects striking the user's hand while they grip the handle bars of the vehicle.

The handle bars include control features of the vehicle including the grip, brake, throttle, and clutch levers. With these features on the handle bars, it is desirable to protect the user from the elements encountered.

### SUMMARY

Embodiments include a hand guard apparatus mounted onto the handle bars of a vehicle for protecting the hand of a user of the vehicle as the user grips the set of handle bars. The hand guard apparatus includes a bracket that includes an orifice, a pivot bolt substantially cylindrical in shape, the pivot bolt arranged in the orifice, a body portion connected to the bracket, and a pivot bolt fastener configured to retain the pivot bolt and the bracket.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 illustrates an exploded rear view of a hand guard assembly;

FIG. 2 illustrates a side view of a pivot bolt;

FIG. 3 illustrates a rear view of the hand guard;

FIG. 4 illustrates an exploded view of the hand guard and a hand grip of a vehicle as viewed from the rear of the hand guard;

FIG. 5 illustrates an exploded view of the hand guard attaching to a hand grip of a vehicle viewed from the front of the hand guard;

FIG. 6 illustrates a top view of the hand guard;

FIG. 7 illustrates a side view of the hand guard;

FIG. 8 illustrates a rear view of an alternate embodiment of the hand guard;

FIG. 9 illustrates a rear view of an alternate embodiment.

FIG. 10 illustrates a rear view of an alternate embodiment of the hand guard;

FIG. 11 illustrates a partially exploded view of an alternate embodiment of the hand guard; and

FIG. 12 illustrates a rear view of a portion of the hand guard assembly as the distal end of the hand grip is engaged with the side of the body portion.

### DETAILED DESCRIPTION

In accordance with exemplary embodiments, the disclosure relates to an apparatus, which is mounted onto the handle bars of a vehicle such as, for example, a motorcycle, motor bike, non-motorized bicycle, or all-terrain vehicle (ATV) and is configured to protect the hand of a user.

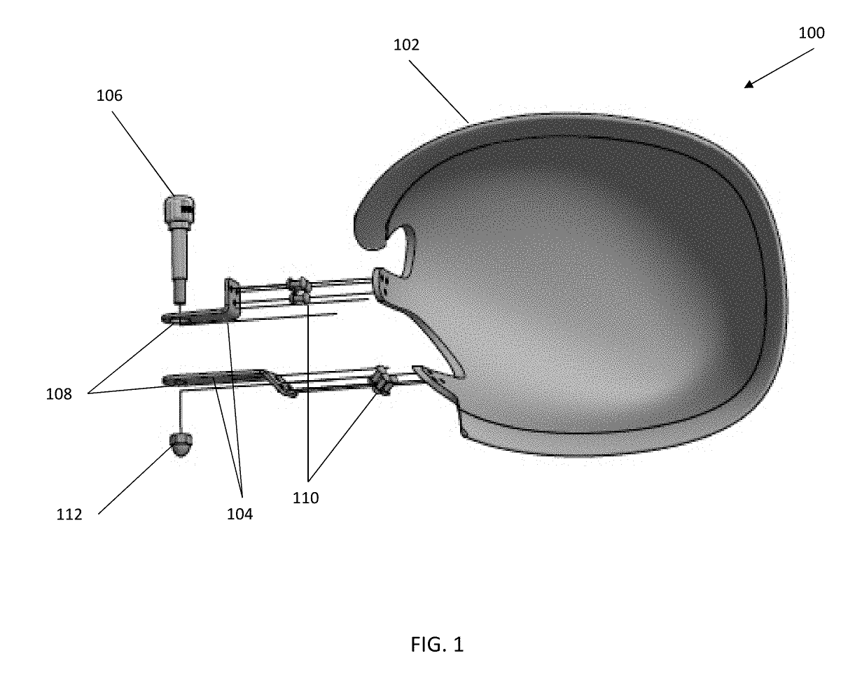

FIG. 1 illustrates an exploded rear view of a hand guard assembly 100 for a vehicle. The hand guard assembly 100 includes a body portion 102, a bracket portion 104 that is connected to the body portion 102, and a pivot bolt 106. The bracket portion 104 includes orifices 108, which are sized and shaped to receive the pivot bolt 106. In the illustrated exemplary embodiment, the bracket portion 104 is connected to the body portion 102 by fasteners 110. When assembled, the pivot bolt 106 is inserted through the orifices 108 and secured via a pivot bolt fastener 112.

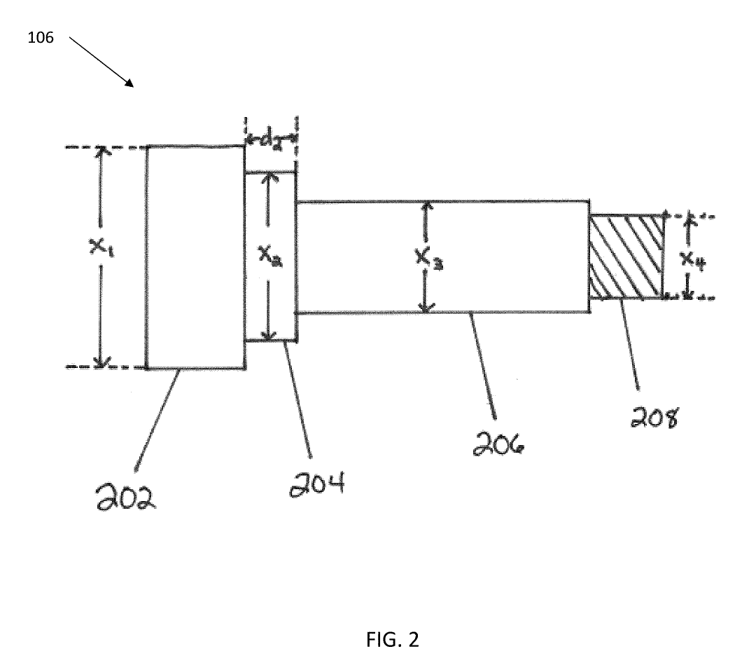

FIG. 2 illustrates a side view of the pivot bolt 106. The pivot bolt 106 has a substantially cylindrical shape with regions of varying circumferences along the length of the pivot bolt. The top region of the pivot bolt 202 has a first circumference x₁ that is greater than the circumference of the orifices 108 of the bracket portions 104 found in FIG. 1. The second region of the pivot bolt 204 has a second circumference x₂ which is less than the circumference of the orifice 108 of the top bracket portion 104 and has a length d₂ substantially equal to the depth of the orifice 108 of the top bracket portion 104. The third region of the pivot bolt 206 has a third circumference x₃ that is less than the circumference of the orifice 108 of the top bracket portion but greater than the circumference of the orifice 108 of the bottom bracket portion. The third circumference x₃ is sized to fit a length to accommodate attachment of the hand guard assembly 100 to a set of handle bars (not shown). The fourth region of the pivot bolt 208 has a fourth circumference x₄ which is less than the circumference of both orifices 108 of the bracket portion 104. In the illustrated embodiment, the fourth region of the pivot bolt 208 is threaded to receive the pivot bolt fastener 112 as shown in FIG. 1.

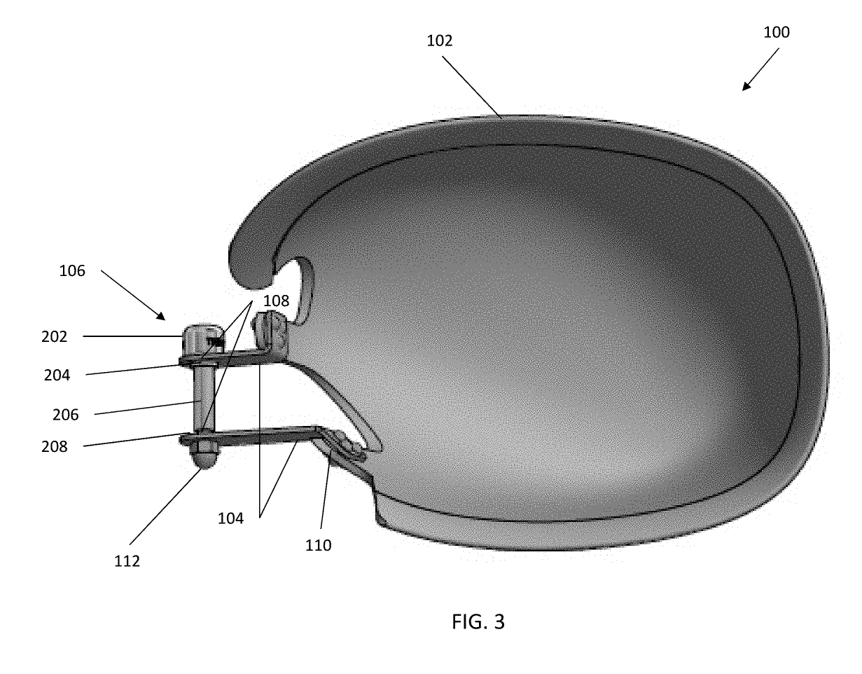

FIG. 3 illustrates a rear view of the hand guard assembly 100. The bracket portion 104 is connected to the body portion 102 by fasteners 110. In the illustrated embodiment, the fasteners 110 appear as rivets. In other embodiments, the fasteners 110 may include, for example, bolts, clamps, clips, screws, hooks, or clasps. The pivot bolt 106 is inserted through the orifices 108. The pivot bolt fastener 112 secures the pivot bolt 106 to the bracket portion 104.

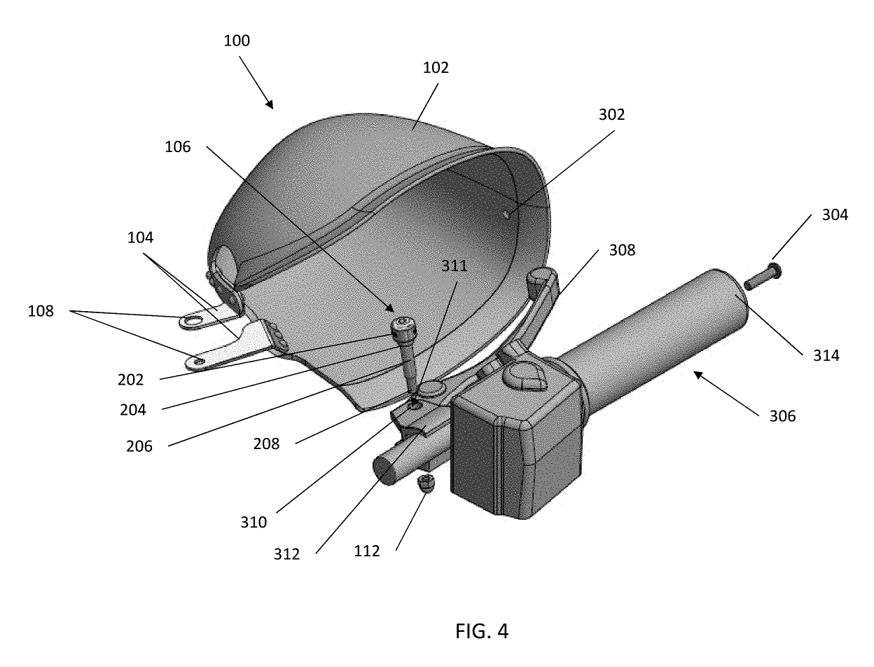

FIG. 4 illustrates a partially exploded perspective view of the hand guard assembly 100 and a hand grip 306. The hand grip 306 includes a control lever 308 that is coupled to the hand grip 306 by a control lever bracket 312. The control lever 308 can be a brake lever, clutch lever, or any other lever attached the hand grip 306. The control lever bracket 312 has an orifice 310 and the control lever 308 has an orifice 311. Both of these orifices are sized to receive the pivot bolt 106. When the pivot bolt 106 is inserted through the orifice 310 of the control lever bracket 312 and the orifice of the control lever 308, the control lever 308 is operable to swivel around the pivot bolt 106.

The hand guard assembly 100 is coupled to the hand grip 306 by arranging the bracket portion 104 over the control lever 308 and control lever bracket 312 and aligning the top and bottom orifices 108 of the bracket portion 104 with the top and bottom orifices 310 of the control lever bracket 312 and the orifice 311 of the control lever 308 and inserting the pivot bolt 106 through the top orifice 108 of the bracket portion 104 down through the orifice 310 of the control lever bracket 312 and orifice of the control lever to the bottom orifice 108 of the bracket portion 104. The pivot bolt 106 is secured by the pivot bolt fastener 112. In one or more embodiments, the orifice 310 of the control lever bracket 312 is threaded and configured to receive the pivot bolt 106 threading. The pivot bolt fastener 112 can include, for example, a lock nut.

In the illustrated embodiment, the pivot bolt 106 contains several regions (202, 204, 206, and 208), which are configured to couple the hand guard assembly 100 to the control lever 308 and control lever bracket 312 by insertion through the orifices 108 of the bracket portion 104, the orifice 310 of the control lever bracket 312 and the orifice of the control lever 308. The top region of the pivot bolt 202 is sized to be greater than each orifice 108 of the bracket portion 104, the orifice 310 of the control lever bracket 312 and the orifice of the control lever 308. The second region 204 is sized to fit through the top orifice 108 of the bracket but not the orifice 310 of the control lever bracket 312 and the orifice of the control lever 308 while the pivot bolt 106 is engaged. The second region 204 has a depth that is substantially equal to the depth of the top orifice 108 of the bracket portion 104 so that when the pivot bolt 106 is engaged in the orifice 310 of the control lever bracket 312 and the orifice of the control lever 308, the top bracket portion 104 has an orientation that is substantially flush to the top of the control lever bracket 312. The third region of the pivot bolt 206 is sized to fit through the orifice 310 of the control lever bracket 312 and the orifice of the control lever 308. The fourth region 208 is sized to fit through all orifices (310, 108, and 311) and is configured to receive the pivot bolt fastener 112.

Though the illustrated embodiment shows the pivot bolt 106, other pivot bolt designs may be used to engage the orifices described above. In one or more embodiments, the pivot bolt 106 can be an axle, bearing, or bolt for control levers provided by the original equipment manufacturer or an after-market equipment manufacturer of the vehicle or handle bars.

In the illustrated exemplary embodiment, the bracket portion 104 includes a first arm and a second arm. The first arm and second arm each include orifices 108. The size of the orifices 108 of the first arm and the second arm can be different from each other. Though the illustrated embodiment shows the bracket portion 104 as two brackets, the bracket portion may be a single bracket or multiple brackets.

In the illustrated exemplary embodiment, the pivot bolt fastener 112 appears as a nut. In other embodiments, the pivot bolt fastener 112 may include any other suitable type of fastener such as, for example, a cotter pin, a screw, a hook, a clip, a clasp, or a rivet.

The body portion 102 includes a side orifice 302 sized to receive a side fastener 304 that connects the side of the body portion to the distal end 314 of the hand grip 306 of the vehicle. In the illustrated exemplary embodiment the fastener 304 includes a threaded portion that engages corresponding threads in the side orifice 302. In one or more exemplary embodiments, the fastener 304 may include any suitable type of fastener such as, for example, a cotter pin, a screw, a hook, a clip, a clasp, or a rivet.

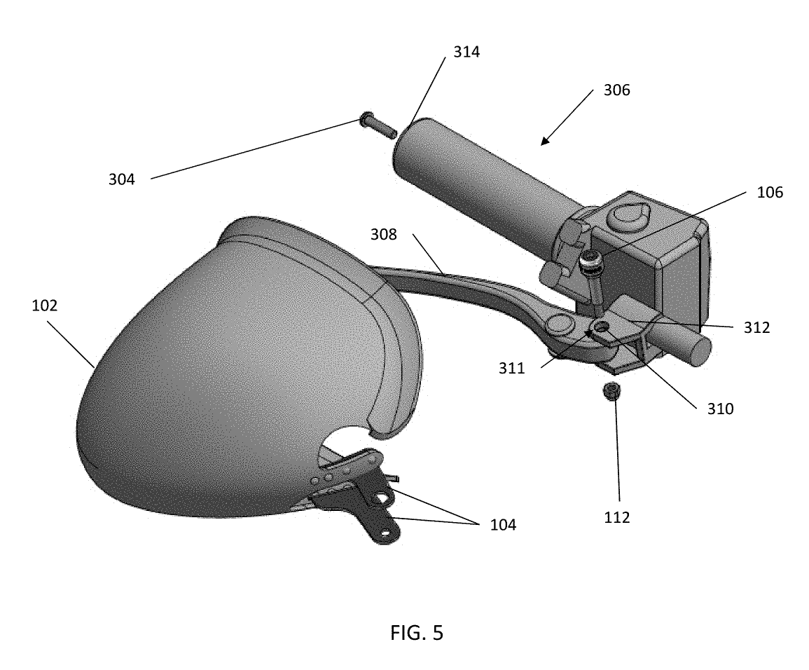

FIG. 5 illustrates an exemplary embodiment of a perspective view of the hand guard assembly 100 and a hand grip 306.

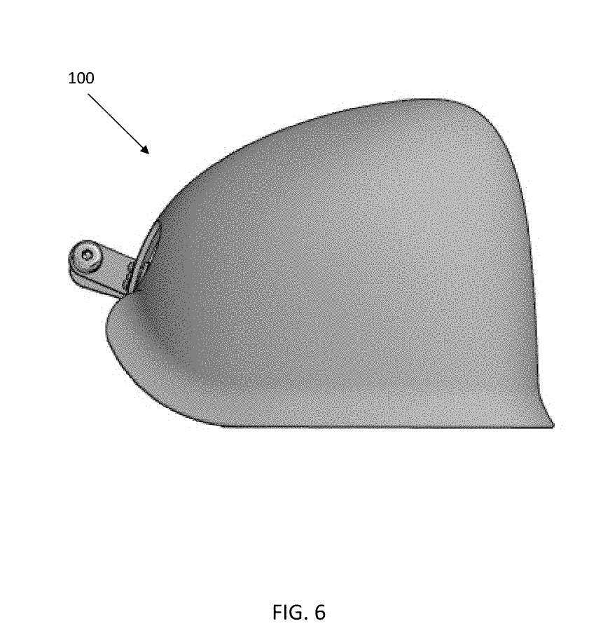

FIG. 6 illustrates an exemplary embodiment of a top view of the hand guard assembly 100 for a vehicle.

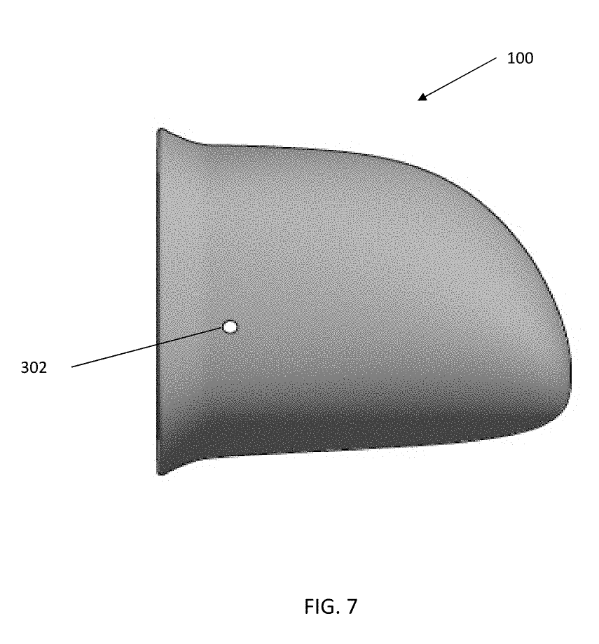

FIG. 7 illustrates an exemplary embodiment of a side view of the hand guard assembly 100 showing the side orifice 302.

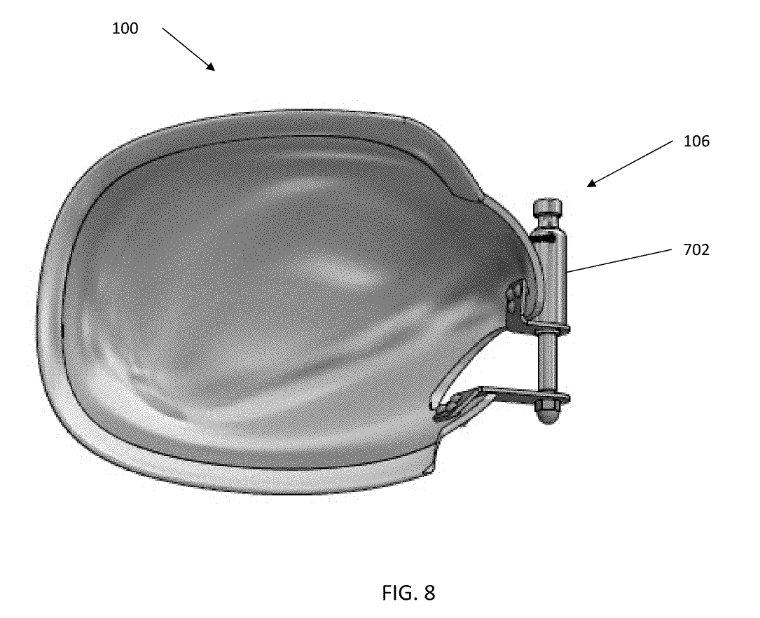

FIG. 8 illustrates an exemplary embodiment of a rear view of the hand guard assembly 100 for a vehicle. The pivot bolt 106 includes a lengthened top region of the pivot bolt 702 that has a length that is longer than the length of the top region of the pivot bolt 202 from FIG. 2. This lengthened top region 702 is sized to receive and support a helmet of a user or other user accessories.

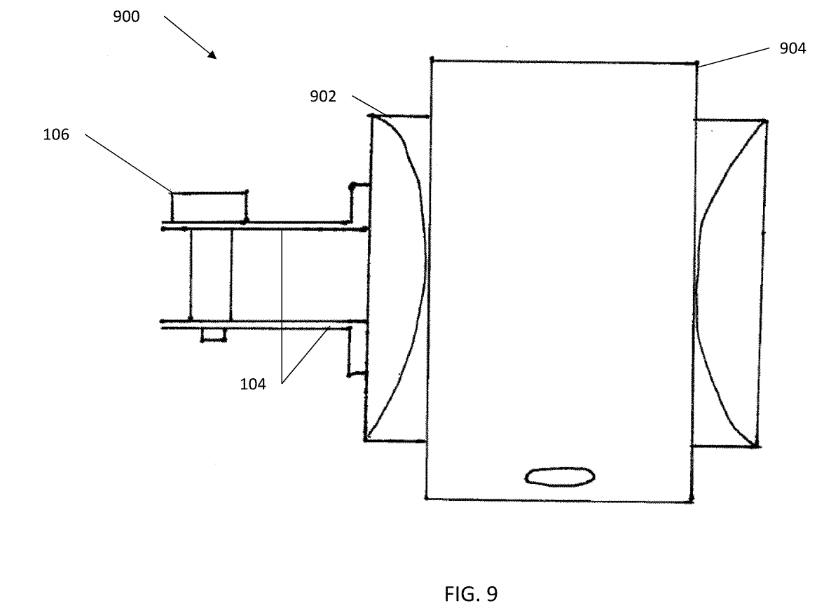

FIG. 9 illustrates a rear view of an alternate embodiment of the apparatus 900. The apparatus 900 includes a holder portion 902, a bracket portion 104 that is connected to the holder portion 902, and a pivot bolt 106. The holder portion 902 is configured to hold an accessory device 904. The accessory device 904 may include, for example, a cellular telephone, a media device, a cup, or a global positioning system (GPS) device. The bracket portion 104 is secured to the hand grip 306 via the pivot bolt 106 and pivot bolt fastener 112 as described above.

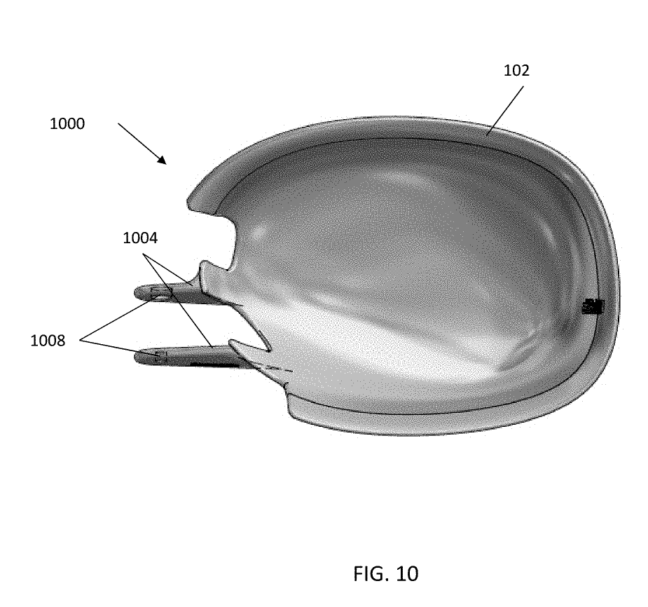

FIG. 10 illustrates a rear view of an alternate embodiment of the hand guard. The hand guard assembly 1000 includes a body portion 102 and a bracket portion 1004. In the illustrated example, the bracket portion 1004 and the body portion 102 are a single, unitary member where the hand guard assembly 1000 is made from, for example, an injection molding process or any other suitable process for forming and manufacturing the hand guard assembly 1000. The bracket portion 1004 includes orifices 1008, which are sized and shaped to receive a pivot bolt 106 (of FIG. 1).

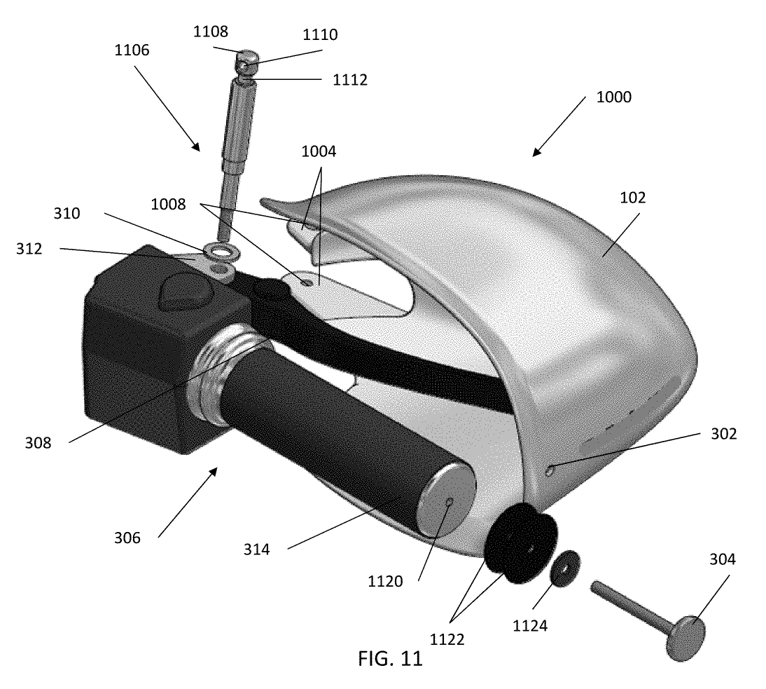

FIG. 11 illustrates a partially exploded perspective view of an alternate embodiment of the hand guard assembly 1000 attaching to a hand grip 306. As described above, the hand grip 306 includes a control lever 308 that is coupled to the hand grip 306 by a control lever bracket 312. The control lever bracket 312 has an orifice 310 and the control lever 308 has an orifice 311 (of FIG. 4). Both of these orifices are sized and shaped to receive the pivot bolt 1106. When the pivot bolt 1106 is inserted through the orifice 310 of the control lever bracket 312 and the orifice of the control lever 308, the control lever 308 is operable to swivel around the pivot bolt 1106.

The hand guard assembly 1000 is coupled to the hand grip 306 by arranging the bracket portion 1004 over the control lever 308 and the control lever bracket 312 and aligning the top and bottom orifices 1008 of the bracket portion 1004 with the top and bottom orifices 310 of the control lever bracket 312 and the orifice 311 (of FIG. 4) of the control lever 308 and inserting the pivot bolt 1106 through the top orifice 1008 of the bracket portion 1004 down through the orifice 310 of the control lever bracket 312 and the orifice of the control lever to the bottom orifice 1008 of the bracket portion 1004. The pivot bolt 1106 is secured by a pivot bolt fastener 112 (of FIG. 4). In one or more embodiments, the orifice 310 of the control lever bracket 312 is threaded and configured to receive the pivot bolt 1106 threading.

The pivot bolt 1106 includes a top region 1108 and a recessed region 1112. The top region 1108 includes an orifice 1110 operable to receive a tool inserted through the orifice 1110 to assist with rotating the pivot bolt 1106 along the longitudinal axis of the shaft of the pivot bolt 1106. The tool inserted through the orifice 1110 can be any type of tool such as, for example, a nail, an Allen wrench, and the like. The top portion 1108 can also be textured for ease of gripping to rotate the pivot bolt 1106 without a tool through the orifice 1110. The recessed region 1112 is sized and shaped to allow for a D-ring to engage the recessed region 1112. For example, a D-ring for a helmet strap can engage the recessed region 1112 allowing for a user to hang the helmet on the pivot bolt 1106.

The body portion 102 includes a side orifice sized to receive a side fastener 304 that connects the side of the body portion 102 to the distal end 314 of the hand grip 306. The side fastener 304 has a threaded portion that engages corresponding threads in the side orifice 302. Additionally, the hand grip 306 has a grip side orifice 1120. The side fastener 304 is sized and shaped to be inserted into the grip side orifice 1120. The threaded portion of the side fastener 304 engages corresponding threads in the grip side orifice 1120. The top portion of the side fastener 304 can be textured for ease of gripping to rotate the side fastener 304 without the need for a tool. The side fastener 304 can be inserted through one or more spacers 1122. The spacers 1122 are sized and shaped to fill any space between the distal end 314 of the hand grip 306 and the side orifice 302 of the body portion 102. The spacers 1122 can be any material such as, for example, rubber, metal, or plastic. Each spacer 1122 includes an orifice configured to receive the side fastener 304. The spacers 1122 can include an orifice that is threaded and configured to receive the side fastener 304 threading.

One or more low friction spacers 1124 can be inserted between the spacers 1122 and the inside of the body portion 102. The low friction spacer 1124 allows for the hand grip 306 to rotate along the longitudinal axis and reduce any friction between the distal end 314 of the hand guard 306 and the inside of the body portion. The low friction spacers 1124 can be inserted between the top portion of the side fastener 302 and the outside of the body portion 102 when the side fastener 304 is engaged with the side orifice 302. The low friction spacer 1124 can be any low friction material. The low friction spacer 1124 includes an orifice configured to receive the side fastener 304 and/or the threading of the side fastener 304.

A hand grip sleeve can be utilized by an operator of a vehicle to increase the diameter of the hand grip 306. The hand grip sleeve can also increase the length of the hand grip 306 extending the distal end 314. The spacers 1122 and the low friction spacers 1124 can be added or removed to account for any increased space caused by the hand grip sleeve. Additionally, vehicle manufacturers can have non-uniform length hand grips that would require the addition and removal of spacers 1122 to adjust for the space between the distal end of the hand grip and the inside of the body portion 102 of the hand guard.

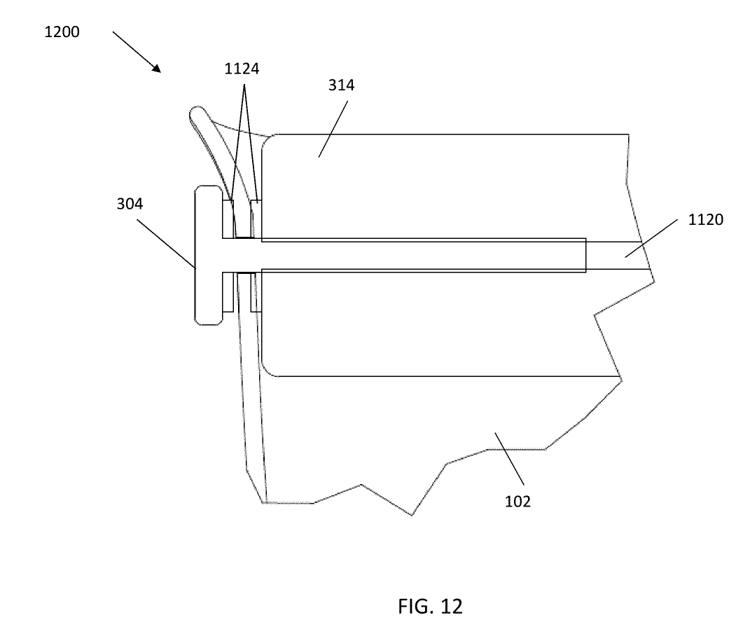

FIG. 12 illustrates a rear view of a portion 1200 of the hand guard assembly 100 or 1000 as the distal end 314 of the hand grip 306 is engaged with the side of the body portion 102. The low friction spacers 1124 are engaged between the distal end 314 of the hand grip 306 and the inside of the body portion 102 and also engaged between the top portion of the side fastener 304 and the outside of the body portion 102. The grip side orifice 1120 is engaged by the side fastener 304. In the illustrated example, the distal end 314 of the hand grip is of a length that requires only low friction spacers 1124. However, in other embodiments, the hand grip length can require one or more spacers 1120 and low friction spacers 1124 to fill the space between the distal end 314 and the inside of the body portion 102.

In one or more embodiments, the body portion 102 is contoured to allow the control lever 308 to operate unimpeded while the hand guard assembly 100 and 1000 is coupled to the hand grip 306.

In one or more embodiments, the body portion 102 is contoured to at least partially encompass the hand and wrist of the user of the vehicle as the user grips the hand grip 306.

What is claimed is:

1. A hand guard apparatus comprising:
a bracket that includes an orifice;
a pivot bolt substantially cylindrical in shape, the pivot bolt arranged in the orifice;
a body portion connected to the bracket; and
a pivot bolt fastener configured to retain the pivot bolt and the bracket.

2. The apparatus of claim 1, wherein the pivot bolt includes regions of different circumferences each region configured to insert into the orifice of the bracket.

3. The apparatus of claim 1, wherein the body portion is shaped to at least partially encompass a hand grip of a handle bar assembly on a vehicle.

4. The apparatus of claim 3, wherein the body portion includes a side orifice on a side of the body portion.

5. The apparatus of claim 1, wherein the bracket includes a first arm and a second arm, wherein the first arm includes the orifice and the second arm includes a second orifice, the second orifice operative to receive the pivot bolt.

6. The apparatus of claim 1, wherein the body portion is connected to the bracket with a fastener.

7. An apparatus comprising:
a control lever bracket having an orifice;
a control lever having an orifice arranged in the control lever bracket;
a body portion;
a bracket connected to the body portion, the bracket including an orifice, the bracket arranged on the control lever bracket; and
a pivot bolt engaging the orifice of the bracket, the orifice of the control lever bracket, and the orifice of the control lever.

8. The apparatus of claim 7, further comprising a hand grip at least partially arranged in the body portion.

9. The apparatus of claim 7, wherein the pivot bolt includes regions of different circumferences each region configured to insert into the orifice of the bracket.

10. The apparatus of claim 8, further comprising:
a side fastener, wherein the side fastener is sized to insert into a side orifice on a side of the body portion; and
wherein the side fastener operatively connects the side of the body portion to a distal end of the hand grip.

11. The apparatus of claim 7, wherein the bracket includes a first arm and a second arm, wherein the first arm includes the orifice and the second arm includes a second orifice, the second orifice operative to receive the pivot bolt.

12. The apparatus of claim 11, wherein the first arm and the second arm are arranged on opposing sides of the control lever bracket.

13. The apparatus of claim 7, wherein the pivot bolt passes through the orifice of the bracket, the orifice of the control lever bracket and the orifice of the control lever.

14. The apparatus of claim 7, wherein the body portion is connected to the bracket with a fastener.

15. An apparatus comprising:
a bracket that includes an orifice;
a pivot bolt substantially cylindrical in shape, the pivot bolt arranged in the orifice;
a holder portion connected to the bracket; and
a pivot bolt fastener configured to retain the pivot bolt and the bracket.

16. The apparatus of claim 15, wherein the holder portion is configured to hold at least one of a cellular telephone, a media device, and a global positioning system (GPS) device.

17. The apparatus of claim 15, wherein the pivot bolt includes regions of different circumferences each region configured to insert into the orifice of the bracket.

18. The apparatus of claim 15, wherein the holder portion is shaped to at least partially encompass a hand grip of a handle bar assembly on a vehicle.

19. The apparatus of claim 15, wherein the bracket includes a first arm and a second arm, wherein the first arm includes the orifice and the second arm includes a second orifice, the second orifice operative to receive the pivot bolt.

20. The apparatus of claim 15, wherein the holder portion is connected to the bracket with a fastener.
